(19) United States
(12) Patent Application Publication
(10) Pub. No.: US 2010/0073468 A1
(43) Pub. Date: Mar. 25, 2010

(54) SIMULATION OF ATTENDANCE AT A LIVE EVENT

(76) Inventor: Ben KUTNER, Ottawa (CA)

Correspondence Address: POLSINELLI SHUGHART PC, 700 W. 47TH STREET, SUITE 1000, KANSAS CITY, MO, 64112-1802, US

(21) Appl. No.: 12/506,777

(22) Filed: Jul. 21, 2009

Related U.S. Application Data
(63) Continuation-in-part of application No. 10/938,125, filed on Sep. 10, 2004, now abandoned.

(30) Foreign Application Priority Data
Feb. 12, 2002 (CA) 2,371,501

(51) Int. Cl. H04N 7/18; G06F 21/00

(52) U.S. Cl. 348/61; 726/26; 348/E07.085

(57) ABSTRACT

A method and apparatus is provided for creating a simulation of attendance at a live event performance. The apparatus includes an enclosed architectural structure having an interior adapted to replicate a portion of the seating environment of a real life performance venue and having a video projection screen with a panoramic surface and an audio-visual recording device for capturing the same panoramic view and audio as experienced by spectators near the selected vantage point at the real life performance venue. A delivery apparatus is provided to transmit a live or tape delayed feed from the audio-visual recorder and a receiver is provide to receive the live or tape delayed feed and a projection device is located within the enclosed structure, to project the live or tape delayed feed on the video projection screen at a one-to-one scale.

### CROSS REFERENCE TO RELATED APPLICATION

This application is a continuation-in-part of application Ser. No. 10/938,125 filed on Sep. 10, 2004 and this application claims priority benefit to application Ser. No. 10/938,125 filed on Sep. 10, 2004 under 35 U.S.C. 120 the entire subject matter of which, as contained in United States Patent Application Publication No. US 2007/0188712, published Aug. 16, 2007, is incorporated herein by reference.

### FIELD OF THE INVENTION

This invention relates to a System of Producing and reproducing the experience of live attendance and group telepresence at facilities originating visual or performing arts or sports events such as coliseums, concert halls, arenas, stadiums, legitimate and motion picture theatres, auditoriums, visual art galleries and the like, by methods of production of apparent “3D” content and a network of architecturally featured display apparatus and visualization environments.

The system comprises video production using a multiplicity of fixed HD POV cameras, synchronous transmission of a multiplicity of encoded HD video channels and display of said video as panoramic video images in a format which simulates the direct, unmediated viewing of the event or performance from opera boxes, loges or sports boxes, suites, press galleries and the like located at the originating facilities.

The format of the present invention has the features of “virtual” 3D with event content viewed from a fixed oblique, aerial perspective point of view, and with no apparent camera mediation as in broadcast production (i.e. no switching, panning, zoom or tilt, no advertising). The displayed format produces the illusion of depth of field, parallax and perspective, such that the event facility appears as a fixed ground of the event or performance, and moving figures or movable objects appear with corresponding live motion relative to the ground.

The format of the present invention has the visual qualities of a trompe d'oeuil painting or diorama, or a photographic format camera, combined with figures or moving objects displayed in motion relative to the fixed ground.

The visual environments of the present invention are created by a method of systems integration of audio visual apparatuses in combination with actual or simulated architectural featuring (e.g. Using mullions with aggregated flat panels to appear as projecting bay windows), architectural configuration of the visualization environments (e.g. curved or tilted projecting bay windows, modifying interior or exterior glass curtain walls to appear as open portals). The present invention may also utilize the configuration of the visualization environments relative to the space in which they are situated as in a showroom, lobby, atrium vestibule, dining room (e.g. by dropping the floor, curving or tilting the window wall plane or projecting bay windows from outside to inside on exterior walls or modifying interior or exterior walls to appear as open portals so that audio visual apparatus remains outside in a relocatable module or vehicle).

The invention is both novel and an improvement over prior art of the architecture of opera houses, stadium, coliseums and the like by providing a network of unlimited number of remotely located “virtual” boxes, loges, suites, press galleries, as extensions of the actual ones within the facility, and providing substantially identical quality of visual and acoustic experience of live attendance.

The invention is novel and an improvement over the processes of producing live events including cinema exhibition and touring of shows providing an alternative means of permitting widely distributed and incremental seating to audiences and spectators to “virtually attend” any event or performance within local communities, in the architecturally modified displays, portals or telematically equipped theatres (i.e. tele-theatres). The teletheatres are installed in a multiplicity of out-of-home locations but within walking distance from places of residence, so that the collective use of private automobile transportation, and the CO₂ emissions thereof may be substantially reduced. The situating of multiple locations in wide arena networks of said portals and teletheatres provides a substantial construction budget reduction for actual facilities with corresponding number of boxes and seats.

The invention improves upon the priors arts of touring exhibitions or by web casting on web portals visual art such as photography, video, cinema, archival assets, institutions museums and galleries and alternative digital media content enabling the said institutions to virtually extend the viewing, access and attendance at exhibitions and displays of said visual assets to an unlimited number of remote viewers, without the need for costly touring of actual assets. For example, any national art gallery may have a network of “virtual; gallerias” displaying the actual assets by means of the present invention simulating the actual gallery wall displays so the paintings or photographic portraits appear at full size, in salon style etc. The remote viewers physically view and browse the wall as opposed to steer a 360 degree web cam.

The invention establishes a novel method of digital rights management (DRM) and Copy Left principles (reciprocal copyrights) by not reproducing content by a media form such as download copies, film or video prints, or tape or hard or similar copyright-based media in broadcasting and on line regimes, but rather by extending and increasing and the virtualized attendance at one originating production.

### BACKGROUND OF THE INVENTION

Various technologies have been employed to simulate environments, such as for flight simulation and training, as well as for increasing the perception of realism of multi-media presentations. Existing systems typically focus on technological developments and improvements but do not disclose a method or framework for distribution to multiple audiences at multiple locations, nor do they disclose the simultaneous re-creation of the experience of being at a live event for an audience at a remote location.

For instance, U.S. Pat. No. 6,141,034 issued to McCutchen on Oct. 31, 2000, describes a camera for dodecahedral imaging and a modular global video projector for projecting up to an entire spherical image. The patent also includes an easily assembled modular screen for a dome theatre with a plurality of screen elements attached to a geodesic framework. The invention focuses on the technological aspects of photographing and projecting an image onto spherical screens.

U.S. Pat. No. 5,130,794 issued to Ritchey on Jul. 14, 1992, describes a panoramic based virtual reality display system that divides a composite image into a plurality of image segments for display on individual displays of multiple video display assemblies. The images are gathered by a panoramic optical assembly for distribution on the video displays. The drawings show a cube arrangement, see FIGS. 34 through 39. Multiple display assemblies are preferably housed within a closed structure and are mounted in all viewable directions. The display assembly comprises a structure that encloses an audience or even a single viewer. The display units utilized in that patent include flat panels such as large plasma, electroluminescent or liquid crystal displays as well as rear projection screens. U.S. Pat. No. 5,023,725 issued to McCutchen on Jan. 11, 1991 describes dodecahedral imaging and the associated technology for photography and projection. The patent is geared towards the projection of apparently continuous images across the interior surface of a dome or spherical theatre by projecting pentagon shaped image frames onto the interior of the dome.

Training environments and flight simulators also employ similar technology. Examples are Canadian Patent No. 2,287,650 issued to Amery on May 20, 2000 and U.S. Pat. No. 5,137,450 issued to Thomas on Aug. 11, 1992. Amery describes simulating training environments, such as for flight simulation. The invention includes a number of adjacent video image generation and display modules. Each module includes an image generator that generates a video image that is a portion of a composite display image. The image generation and display modules are preferably mounted in a supporting structure designed to hold each of the modules. Thomas describes a wrap around display system for presenting visual imagery for a flight simulator. The display system includes eight identical pentagon shaped translucent rear projection screens joined together at their edges to form a partial dodecahedron. The projection devices are mounted outside the partial dodecahedron to direct an appropriate simulator image to the rear of a pentagon screen.

The above cited patents disclose technologies for and architectures of virtual reality environments. However, none disclose the simultaneous visual simulation of an actual event presented at a remote location from that event as viewed from a fixed location. Although television broadcasts allow a viewer to witness an event from his or her own home, a television broadcast detracts from the “reality” experienced by the viewer as there are voice overs, replays, and various selected views of the event presented. Therefore, the viewer is not immersed in a life-like environment.

Moreover, it is very common to equip a bar or tavern with televisions, especially large screen televisions, to permit the broadcast of sports events such as football, soccer or hockey games. The televisions are situated so that patrons can see them from their tables or from the bar, and enjoy the broadcasts while consuming various products offered for sale. Therefore, it will be understood that such establishment strive to provide quality televisions, with high fidelity speakers. There are limits to broadcast quality and the fact that commentary is an integral part of the broadcast makes it desirable to keep the volume turned up. However, this can be somewhat overpowering and it is difficult to strike a balance between the need for sound, and the desire to keep the volume at an acceptable level. A further drawback of using broadcast signals is that the broadcast will contain many advertisements, which can be very annoying to the patrons of a bar or tavern. It is therefore an object of the present invention to provide a means by which sports or other live action events can be presented in a commercial establishment like a bar or tavern, by transforming the look and feel of all or a part of the establishment to resemble a loge or suite at a sports area or stadium. The open front end of the loge or suite is provided with a high definition viewing screen for presenting sports events just as they would be viewed from a similar large or suit at the event. This is accomplished by presenting on the screen only the video feed from one unmoving location, at the event being presented. The video feed does not follow the action, but permits a viewer to follow the action by focusing on different parts of the screen. No commentary other than that from the public address system is available, and no replays are broadcast. The score of the game can be discerned only by viewing the stadium clock, which will be part of the video feed, at all times.

### SUMMARY OF THE INVENTION

It is, therefore, a principal object of the invention to provide a method to simulate attendance at a live event or performance. Unlike the above cited patents, the invention disclosed herein contemplates a series of enclosed architectural structures located at various sites in various cities, wherein a broadcast video of a live event or performance is presented to an audience on a wide angle screen surface. The invention simulates a real life event for a remote audience as if the audience were actually at the event sitting in the best seats. For example, a play-off hockey game may be presented from seats looking down on centre ice. Because of the present invention, this experience can be simulated for many viewers at many different sites at the same time as the actual hockey game is taking place. This allows many more fans to “attend” and enjoy the same experience for a reduced price of a ticket to the live event. To further enhance the life-like experience, the interior of the theatre structure is adapted to replicate a portion of the seating environment of a real life performance

Similarly, the simulation and immersive feeling of being in virtual attendance at a performance such as live theatre or a concert is contemplated. The panoramic view of the proscenium stage and adjacent auditorium as seen from a loge or box seat in various performing arts and culture facilities may be presented to remote audiences.

The enclosed architectural structure can be built at existing business establishments either as part of an existing room, or as an addition to a building. For example, the enclosed architectural structure can be built into an existing bar or pub where patrons can enter the architectural structure which can be closed off from the rest of the bar. The interior of the architectural structure is adapted to look like hockey arena seating or it can replicate the interior of a suite at the arena. A further option is to replicate the seating of a loge at the arena. The patron, once inside the enclosed architectural structure can view the hockey game as if he or she were actually at the arena. Visually, the interior design of the enclosed architectural structure combined with the use of a panoramic screen showing the game being played out on the ice, replicates the loge, suite and audience environment of the arena.

A framing device to cover and hide the edges of the screen is placed situated between the viewers and the panoramic screen. This enhances the viewer's feeling that they are looking out of a loge or a suite's window down towards the ice and the hockey players over the heads of the real audience. This effect is further enhanced by setting the screen back from the framing device. The frame is also used to perceptually eliminate the presence of the screen by hiding its edges. The frame also covers up the edges of the panoramic screen where there is usually distortion in the projected image.

The invention comprises a video camera or digital imaging device to record a real-time, or near real-time event or performance and capture a wide field, preferably greater than a viewer's field of vision. The device is to be positioned at a selected vantage point and set in a fixed position. For example, the digital imaging device may be positioned in a box or loge seat at the arena of a hockey game so as to capture the same view as that of a person in attendance at the game and sitting in that same box or loge seat. The camera captures a panoramic view of the entire visual space of the venue without the need for panning horizontally or vertically.

The invention replicates the exact viewing experience and audio experience of the persons at a real life hockey game for a virtual audience. The view is the same as that of the person who would be sitting in the seat where the video camera is located. There are no zoom in shots or commercial breaks and if someone in a seat in front jumps up and blocks the camera's view, then that is what the virtual audience will see.

The preferred embodiment employs a video camera that is a high resolution imaging camera, such as DALSA (digital camera), Ikegami (HDTV), Thomson Multi-Media (HDTV or digital camera).

The invention further comprises a delivery means to transmit a live or stored delayed feed from the video camera and event to a remote location. The delivery means may include a satellite, or an equivalent transmission system, capable of high speed broadband digital video (for example, at 270 megabytes per second or greater) on multiple channels. Such a system allows for transmission of the live or delayed feed to a plurality of remote locations.

A receiving means receives the live or stored delayed feed and a projection means projects the images onto a video projection screen or a visual display system giving a panoramic viewing surface. The projection means can be, but is not limited to, available CRT, DLP or DILA projectors by various manufacturers such as CHRISTIE, BARCO and JVC. The mode of presentation at the remote location can also include and is not limited to high definition television, multiple video display assemblies, rear and frontal projection screens, and three dimensional viewing surfaces such as the inside of a dome structure. The preferred embodiment uses a multi-channel video projection system such as SEOS, FAKESPACE using a mirror assembly behind the screen.

Where the received images are mosaic segments, the projected images may be projected onto a screen in various formats. The invention contemplates use of digital edge blending technology (such as PANORAMTECH and SEOS) to remove grid lines between channels to achieve a uniformly high resolution across the screen. For example, each mosaic segment at 1920 horizontal by 1080 pixels vertical or approximately 4000 by 2000 pixels across the entire screen in a 3 by 2 array.

The structure contemplated for housing the screen and audience at the remote location can be modular and can be developed into a series or network of modules and modular structures. An individual module can encompass a viewing surface and stadium style seating in an audience area opposite the viewing surface.

Ideally, the enclosed architectural structure is of interior or exterior grate construction. The size of the structure in one embodiment is approximately 30 by 30 feet at its base and 18 feet high.

In one embodiment a frame is vertically situated between the stadium style seating and the screen. The audience views the projected video on the screen through an opening in the frame.

The frame opening is positioned and sized such that the peripheral view from any of the seats to the screen or mirror assembly is limited (for example, to angles of approximately 120 to 180 degrees horizontally and 45 to 80 degrees vertically). This prevents the viewers from seeing the screen edges or mirror assemblies. In the preferred embodiment, the opening in the frame is a minimum of approximately 16 feet wide by 9 feet high for optimal viewing of the screen by a smaller audience of 30 to 50 people. In other embodiments, the size of the opening may be multiples thereof or by using the aspect ration of HDTV (being 16:9, horizontal to vertical).

Six projectors are used In the preferred embodiment and these are arranged in two rows of three projectors. The first set of three projectors are arranged horizontally and linearly and are evenly spaced from one another. The projectors can be mounted to the top of the frame outside the audience space thereby being hidden from the view by the audience. These projectors are aimed forwards to the screen or mirror (as in collimation).

The second set of three projectors are arranged horizontally and linearly and are evenly spaced from one another. The projectors are located underneath and outside of the frame. These projectors are aimed forwards and upwards to the screen. The invention allows for the six projectors to be positioned at various angles towards the screen and by means of edge blending to create a single image on the screen without a visible matrix or grid lines.

A person situated at the remote location and viewing the video projection screen will be able to “virtually attend” the live event, performance or the like as if that person were actually in attendance at same.

### BRIEF DESCRIPTION OF THE DRAWINGS

FIG. 1 is a schematic representation of the method for providing a simulation of attendance at a live event, performance or the like.

FIG. 2 is a longitudinal section through the interior of a proposed enclosed architectural structure used to house the audience, projection screen and projector.

FIG. 3 is a plan of an enclosed architectural structure attached to a bar.

FIG. 4 is a plan of an enclosed architectural structure located within a bar.

FIG. 5 shows a plurality of enclosed architectural structures at separate remote locations.

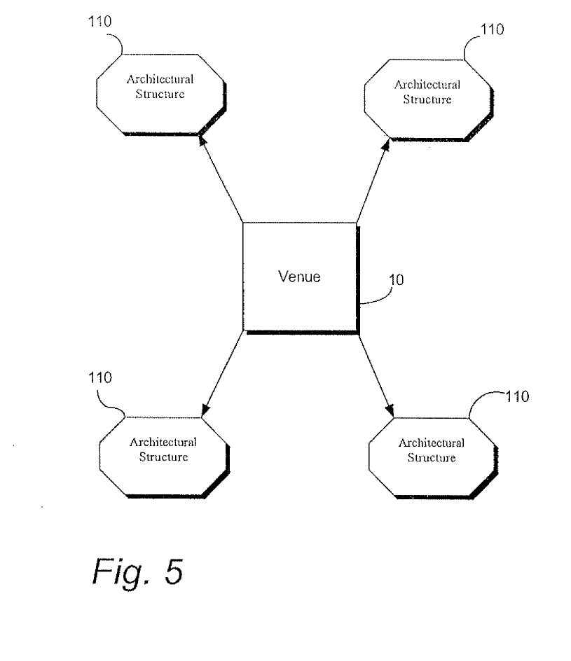

FIG. 6 is a plan view of an array of four screens suitable for use with the present invention.

FIG. 7 is a plan view of an array of a plurality of screens including screens of at least two different sizes, including a side view of a rearwardly tilted screen.

FIG. 8 is a perspective view of the array of screens shown in FIG. 7, tilted rearwardly, to display a hockey game to a plurality of viewers in stadium style seating.

FIG. 9 is a perspective view of an array of screens assembled according to the present invention to display a theatrical production.

### DETAILED DESCRIPTION OF THE DRAWINGS

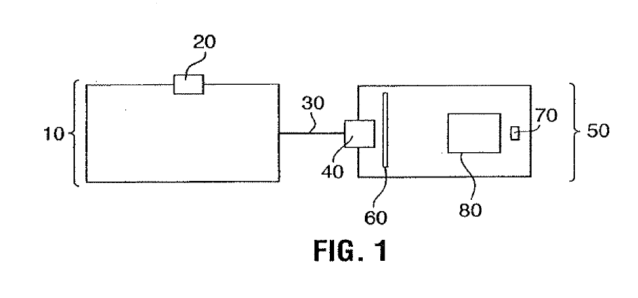

Referring to FIG. 1, a live event or performance is under way at a venue 10 such as a hockey game, or a concert. Affixed video camera 20 is situated at a vantage point within the venue so as to record a wide angle view of the event. The view recorded by the video camera is substantially the view as seen by a person in attendance at the event. Video camera 20 is maintained in a fixed position throughout the performance.

Delivery means 30, transmits the live or tape delayed feed from the video camera to a remote location 50.

A receiving means 40 receives the live or tape delayed feed and relays it to a projection means 70. The image is then projected onto a screen or visual display 60 for viewing by the audience

Stadium style seating 80 may be provided.

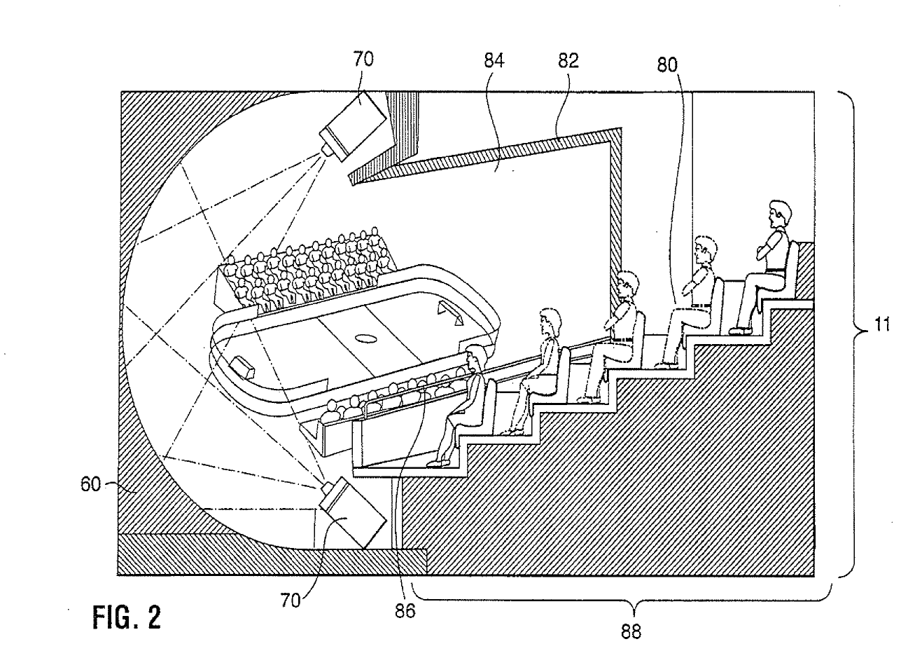

In order that the invention may be more clearly understood, reference is made to FIG. 2, which illustrates a preferred embodiment of the theatre structure, by way of example. FIG. 2 shows the remote location 50 as a theatre structure housing a frontal projection video screen 60 and projection means 70. Stadium style seating 80 is provided in front of the screen. Between the screen and the stadium style seating, is a vertically positioned frame 82 with an opening 84 allowing a view to the screen. A railing 86 protects the audience from failing out of the audience area 88. There may a multiplicity of projectors utilized to project the video onto screen 60. FIG. 2 shows the placement of projection means 70 above the frame opening 84 and outside the audience area 88, hidden from view by the audience. FIG. 2 also shows placement of projection means 70 below the frame opening 84 and outside the audience area 88, hidden from view by the audience.

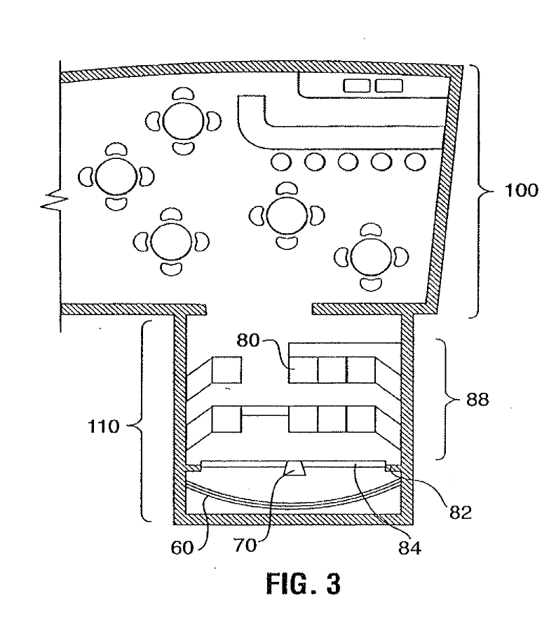

FIG. 3 provides an example of one of the economic applications of the invention. An enclosed architectural structure 110 with stadium style seating 80 replicating the look and feel of a loge at a hockey game is attached to an existing sports bar 100. Customers can mingle in the bar or go and sit in an environment that replicates a loge in a hockey arena and watch a hockey game from the best seats in the house as the hockey game is projected by video projector 70 onto the video projection screen 60. Frame opening 34 is shown and the frame 82 serves to hide the edges of the video projection screen 60 from the sight of the sports bar patrons.

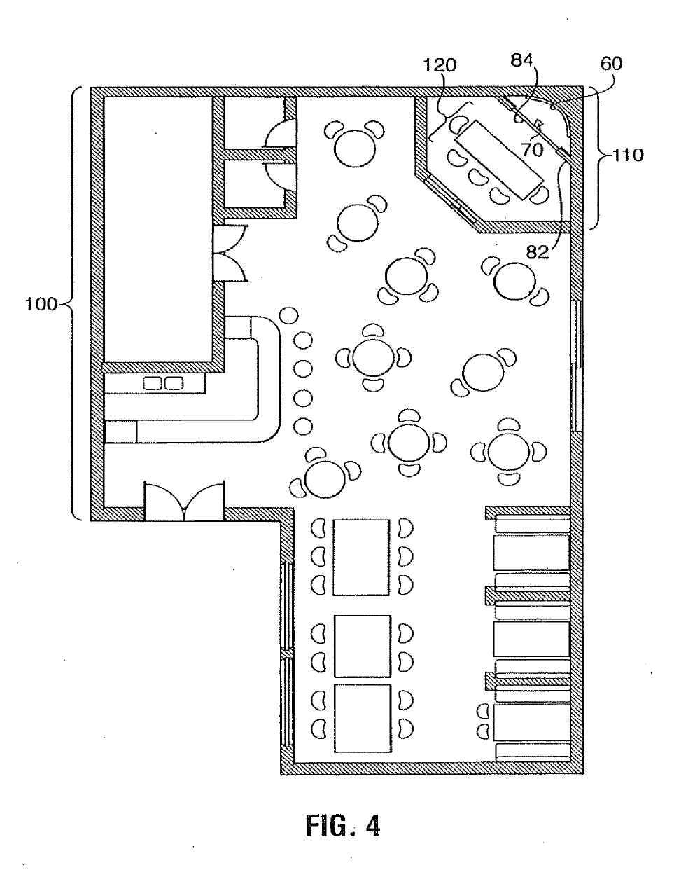

FIG. 4 provides an example of a further economic application of the invention. An enclosed architectural structure 110 with a bar counter and stools 120 is built within a bar 100. The enclosed architectural structure 110 is attached to the seating area of the bar such that customers can mingle in the bar or go and sit at the counter and stools 120 with their drinks and watch that evening's hockey game as if they were actually at the game in an executive suite. Alternatively, corporate sponsors of venues or teams may have an enclosed architectural structure built at their head offices where employees and clients can be given the treat of a “real life” hockey game. Video projection screen 60, projection means 70 and frame 82 and frame opening 84 are also situated in this embodiment of the enclosed architectural structure.

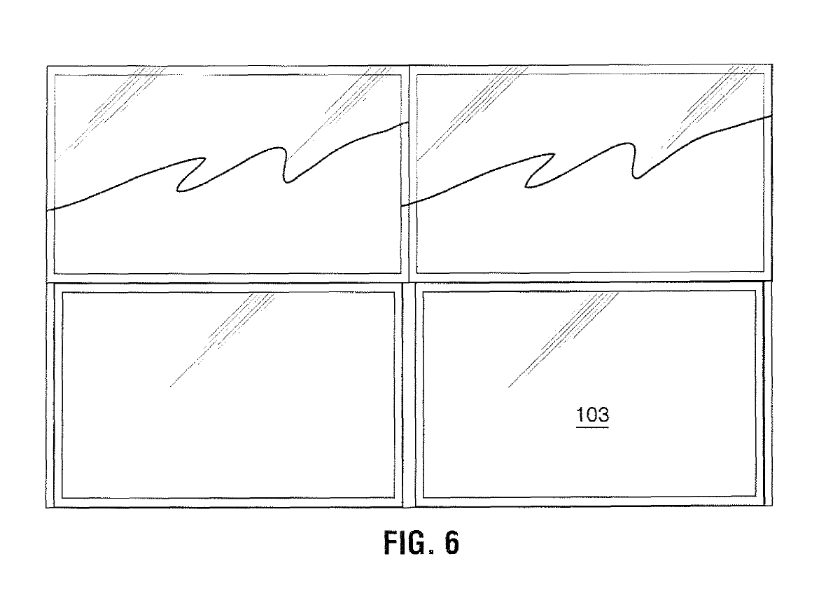

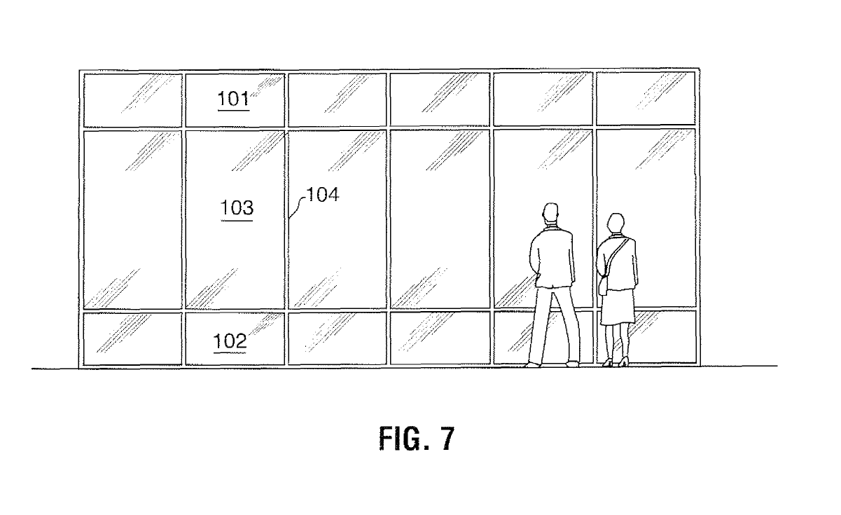

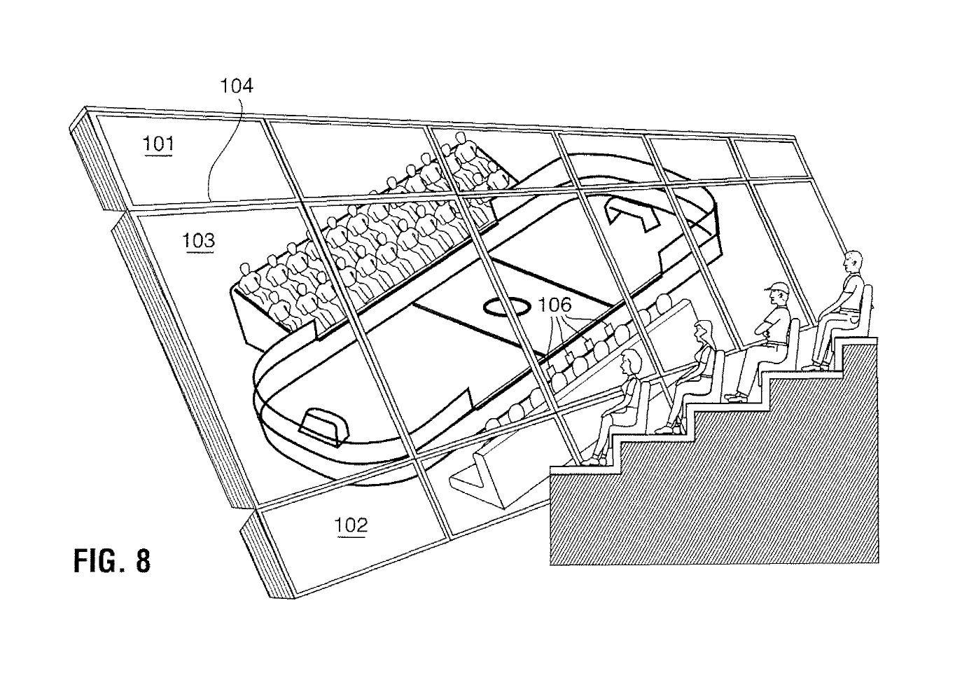

Referring now to FIGS. 6, 7, 8 and 9, preferred screen dimensions and placement relative to viewers is shown. As shown in FIG. 7, the viewing screen on which video images are presented in the method of the present invention may be composed of an array of individual screens including upper screens 101 and lower screens 102, and intermediate screens 103. A plurality of upper 101 and lower 102 and intermediate 103 screens are assembled to create a large rectangular array. Individual screens 101, 102 and 103 are separated, in the embodiments shown, by mullion strips 104 that are selected to blend into the ordinary environment of the event being presented. In the embodiment illustrated in FIGS. 7 and 8, the array of screens is assembled to present a hockey game, and the mullion strips 104 are selected to resemble the strips between protective glass panels in a hockey arena. Since a hockey audience is accustomed to viewing a hockey game through the glass panels, the presence of the mullion strips 104 will not be noticed.

As shown in FIGS. 7 and 8, the screens may be of varying sizes. In these figures, upper 101 and lower 102 screens are shown as horizontally oriented 46 inch screens, and intermediate screens 103 are shown as 82 inch vertically oriented screens. However, as illustrated in FIG. 6, a screen may be made up of an array of horizontally oriented 49 inch screens 105. Any other suitable array of screens may be assembled as desired. Moreover, it is not necessary to utilize an array of smaller screens. A single large screen may be used, but at greater expense.

Furthermore, mullion strips 104, which will clearly not be necessary if a large screen is used, can also be eliminated if the individual screens in an array are assembled in closely abutting relationships, so that the edge of one screen is directly adjacent the edge of the next.

If more than one camera is being used to capture the event that is being shown remotely via the present invention, the cameras are set up in fixed positions so that the image from one camera will be a direct continuation of the image from the adjacent camera. If mullion strips 104 are being utilized in the screen array, the image from a camera may be sent to a single screen or divided by known software between distinct set of screens. The image from the next camera will then be sent to the next screen or set of screens. Since image resolution on a screen, even a high quality high definition screen will in part be determined by the image captured by the camera being used, and since there are practical maximums to the resolution quality that may be obtained by a single camera, it will be understood, then, that by using a plurality of cameras to capture individual pieces of an overall picture, each piece of that overall picture may be displayed at the maximum resolution obtainable considering only the individual camera used for that portion of the picture, and the screen or screens used. This permits display of a true high definition image on a much larger scale than has heretofore been possible.

As can be seen in FIG. 7, presentation of a very life-like image can also be enhanced by tilting the screen relative to the viewing position of the intended audience, so that members of the audience will essentially be viewing the screen at the same angle as they would have been viewing the live event being shown on the screen. By way of example, in FIG. 7, a hockey game is being shown on the screen. A person in attendance at a hockey game will normally be viewing the game from a position above and to one side of the rink, for instance, at the blue line, fifteen rows up, in a suite. This is where the cameras 106 will be positioned, and therefore, the cameras will be tilted down, to “look at” the rink and arena in the same way that a spectator sitting at the same point would be looking down somewhat, at the rink and arena. Four cameras are shown, but any desired number may be used. By tilting the screen, then, a viewer in the audience will orient the optical axis of his or her eyes at an angle normal to the screen, which will create the illusion that the viewer is looking through, not at, the screen.

It will be understood that each of the four cameras will capture a portion of the entire field of view, so that when the images from all are combined, the entire field of view can be presented.

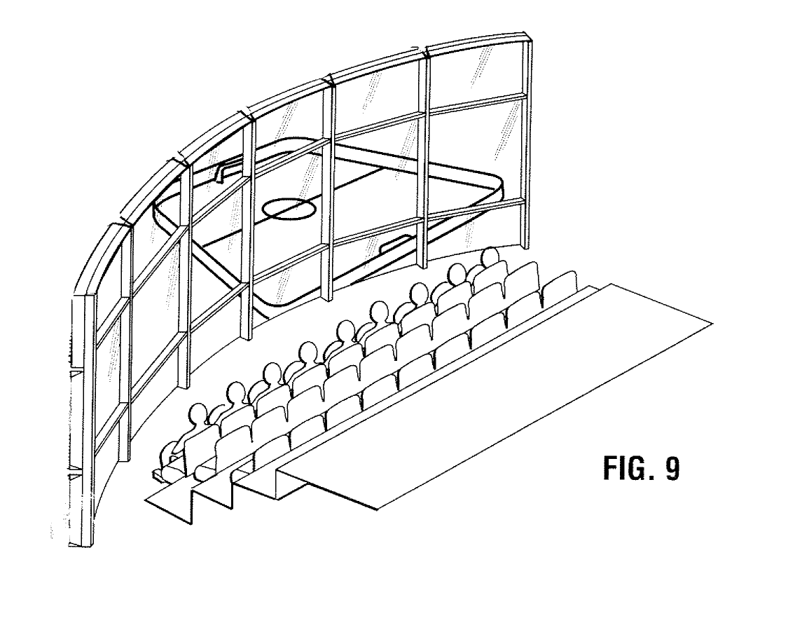

A more theatrical style set up is shown in FIG. 9. In a theatre, the stage is at substantially the same level as most of the seats. That is, except for some balcony seating, most good seats are at about the same level as the stage. However, the audience member will often look from side to side on the stage, as different elements of a performance occur at different parts (right, left, centre) of the stage. Accordingly, for theatrical presentations, a preferred screen arrangement, as shown in FIG. 9 has the screens vertical, but arranged in an arc, so that as a viewer looks right, or left, even extreme right or left, the optical axis of the viewer will continually be at about 90° to the surface of the screen.

In the theatrical presentation shown in FIG. 9, the illusion is assisted by providing a substantial degree of darkness behind the screens. Also, because the audience does not view a theatrical performance through protective glass, it is not practical to use mullion strips between screens. Rather, as shown in detail A of FIG. 9, the individual screens are aligned edge-to-edge, and angled relative to each other.

In view of the foregoing description, various other embodiments are possible. Accordingly, the scope of the appended claims should not be limited to the description of the preferred embodiments contained herein.

I claim:

1. A method of Digital Rights Management (DRM) to establish the virtual attendance or telepresence rights, as opposed to broadcast, simulcast, on line or other place based digital media rights, in order to obtain views within or outside originating facilities and transmit said view content to a network of remotely located displays and visual environments, thereby producing and reproducing the experiences of virtual attendance at live event, performance, sports and arts facilities by methods of production of audio visual format and simulation of architectural paces and visual environments such as boxes, loges, suites, galleries and the like, at locations remote from the actual environments at originating facilities.

2. The method of claim 1 comprising architecturally modifying the originating facility to obtain at least one panoramic view of an event, performance or exhibit from within or outside the said facility, and including the construction of at least one viewing portal in the interior or exterior walls enclosing the event space, stage, screen gallery auditorium to obtain said view.

3. The method of claim 1, comprising imaging by audio-video cameras live events or performances or visual art with a format comprising by a panoramic field of view, a fixed-point oblique aerial perspective, using a fixed, stationary horizontal array of HD video cameras rotated in portrait mode, said format producing continuous series video images of the event or performance as viewed within the originating facility, that can be displayed as a single continuous panoramic image.

4. The method of claim 3, comprising transmitting synchronized output channels of said array of fixed cameras whereby the output of each camera corresponds to one channel, over a WAN or WANs to remote locations, whereupon the synchronized channels are received decoded, and buffered to resynchronize and to display said video with and without edge blending as one, panoramic image with or without seams so that the displayed content of the event appears with a fixed ground and figures in motion.

5. The method of claim 4, further comprising architectural configuration, position and featuring of audio visual display surfaces or apparatus such as LCD or plasma panels to simulate the view within visual environment such as boxes, loges, suites, press galleries, curved or tilted projecting bay windows, said featuring of display surfaces or panels with vertical or horizontal mullions to cover bezels and edge blend seams, or reconstruction of interior and exterior walls with viewing portals or framed openings walls to simulate the identical portal or opening of a box or suites and the like.

6. The method of claim 5, wherein the said architectural configuration or featuring of apparatus is retrofitted within existing interior or exterior space located at a bar, tavern, teletheater, hotel, retail outlet, auto dealers showroom, retirement or nursing home, day care, school, house of worship, lobbies, atrium, galleria or common area in commercial or public buildings.

7. A method of producing or reproducing a live audio and visual performance of an event, said event selected from the group consisting of sports contests, operas, theatrical plays, exhibitions of skill and daring, speeches, musical concerts, ballets, lectures and news making events, comprising the steps of: (a) positioning at least one audiovisual camera having means to capture and transmit an audio and visual signal of said event, at a first selected fixed location relative to the event; (b) while said even is occurring, delivering said audio and visual signal produced at said selected fixed location to a second remote location and second remote location being architecturally designed to resemble at least a portion of the venue at which said even is occurring, said second location being provided with a high resolution video screen and audio speakers, positioned relative to audience seating at said second location so that persons viewing said even shown on said screen will do so at an angle similar to viewers of said event situated in the vicinity of said first location; and (c) receiving said signal at said second location and reproducing it on said screen, wherein during said event, said at least one camera is not moved and continuously transmits a signal corresponding to a single view of said event, without replays, close-ups, narration, panning, or any other technique associated with ordinary commercial television broadcast of like events.

8. A method as claimed in claim 7, said image is displayed on a screen that is positioned and tilted at an angle selected such that the screen is approximately normal to the optical axis of a person viewing same.

9. A method as claimed in claim 8, wherein at lest two said cameras are provided, and the image captured on each is substantially continuous with the image captured on the next adjacent camera.

10. A method as claimed in claim 9, wherein a plurality of high resolution screens are provided, and wherein each screen receives a video feed from one or more of said cameras, whereby image resolution is enhanced over that possible if all screens received a feed from a single camera.
